(19) United States
(12) Patent Application Publication
(10) Pub. No.: US 2018/0232675 A1
(43) Pub. Date: Aug. 16, 2018

(54) METHOD AND SYSTEM FOR DETERMINING PROJECT FACTORS TO ACHIEVE A QUALITY ASSOCIATED WITH A PROJECT

(71) Applicant: WIPRO LIMITED, BANGALORE (IN)

(72) Inventors: VENKATA SUBRAMANIAN JAYARAMAN, CHENNAI (IN); SUMITHRA SUNDARESAN, CHENNAI (IN)

(73) Assignee: Wipro Limited

(21) Appl. No.: 15/470,944

(22) Filed: Mar. 28, 2017

(30) Foreign Application Priority Data
Feb. 13, 2017 (IN) 201741005031

(51) Int. Cl. G06Q 10/06

(52) U.S. Cl. CPC G06Q 10/06313; G06Q 10/06315

(57) ABSTRACT

Disclosed herein is a method and system for determining a plurality of project factors to achieve a quality associated with a project. The method comprises receiving, by an application server, input data from one or more external sources. Upon receiving the input data, determining a value corresponding to each of the plurality of project factors associated with the project using the input data. Also, the method comprises computing cost of quality (COQ) of the project using the value corresponding to the each of the plurality of project factors. Further, determining expected COQ of the project based on an ontology based process, using the computed COQ and data associated with a plurality of projects retrieved from a market research database. Finally, determining the plurality of project factors to achieve a quality based on the computed COQ and the expected COQ

### FIELD OF THE DISCLOSURE

The present subject matter is related, in general to a project management in an enterprise system, and more particularly, but not exclusively to a method and a system for determining a plurality of project factors to achieve a quality associated with a project.

### BACKGROUND

In any enterprise system, quality of a project is equivalent to cost, where quality is associated to total hours spent on improving the quality. Also, knowing parameters associated with the project also facilitates in improving the quality of the project

An enterprise system scrutinizes the way they are spending amount towards quality assurance and how to reduce the amount. Quality assurance (QA) in a project, of an enterprise, is a process which ensures quality of the project, computes total cost of quality and determined factors associated with the project. Presently, cost of quality is considered the cost QA team spends. The computation of cost of quality includes an effort of development team supporting the QA during a testing process. Also, the cost is an essential feature in determining an expected quality of the project. However, there is no mechanism to determine whether the achieved quality of the project is desired or not.

The way the enterprise system is viewing the cost of quality is changing. Also, the enterprise system is unaware of what is the total cost of quality and are there any other hidden cost in the cost of quality. Further, determining parameters associated with the cost of quality is challenging as there is no standard process for identifying the parameters associated with the project. Even if the quality of a project is obtained, there do not exists a process in identifying whether the obtained quality is same as desired quality of the project. Furthermore, there is no mechanism for determining factors of the project which affects quality of the project, which in turn affects the cost of quality of the project.

Disclosed herein is a method for determining a plurality of project factors to achieve a quality associated with a project. The method includes receiving, by an application server, input data from one or more external sources. Upon receiving the input data, the method determines a value corresponding to each of the plurality of project factors associated with the project using the input data. Also, the method comprises computing cost of quality (COQ) of the project using the value corresponding to the each of the plurality of project factors. Further, determining expected COQ of the project based on an ontology based process, using the computed COQ and data associated with a plurality of projects retrieved from a market research database. Finally, determining the plurality of project factors to achieve a quality based on the computed COQ and the expected COQ.

Further, the present disclosure discloses an application server for determining a plurality of project factors to achieve a quality associated with a project. The application server comprises a processor and a memory. The memory may be communicatively coupled to the processor. The memory stores processor-executable instructions. The instruction, upon execution causes the processor to receive input data from one or more external sources. Upon receiving the input data, the application server determines a value corresponding to each of the plurality of project factors associated with the project using the input data. The application server also computes cost of quality (COQ) of the project using the value corresponding to the each of the plurality of project factors. Further, the application server determines expected COQ of the project based on an ontology based process, using the computed COQ and data associated with a plurality of projects retrieved from a market research database. Finally, the application server determines the plurality of project factors to achieve a quality based on the computed COQ and the expected COQ.

Furthermore, the present disclosure discloses a non-transitory computer readable medium including instructions stored thereon that when processed by at least one processor cause an application server 100 to perform acts of receiving input data from one or more external sources and determining a value corresponding to each of the plurality of project factors associated with the project using the input data. Also, computing cost of quality (COQ) of the project using the value corresponding to the each of the plurality of project factors. Further, determining expected COQ of the project based on an ontology based process, using the computed COQ and data associated with a plurality of projects retrieved from a market research database. Furthermore, determining the plurality of project factors to achieve a quality based on the computed. COQ and the expected COQ.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for determining a plurality of project factors to achieve a quality associated with the project, in accordance with an embodiment of the present disclosure;

FIG. 2 shows a detailed block diagram illustrating an application server for determining a plurality of project factors to achieve a quality associated with the project, in accordance with an embodiment of the present disclosure;

FIG. 3A illustrates a block diagram of an input module in accordance with an embodiment of the present disclosure;

FIG. 3B illustrates a block diagram of an analysis module in accordance with an embodiment of the present disclosure;

FIG. 3C illustrates a block diagram of a dynamic engine in accordance with an embodiment of the present disclosure;

FIG. 4 shows a flowchart illustrating a method for determining a plurality of project factors to achieve a quality associated with the project, in accordance with an embodiment of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown or not.

### DETAILED DESCRIPTION

In the present document, the word “exemplary” is used herein to mean “serving as an example, instance, or illustration.” Any embodiment or implementation of the present subject matter described herein as “exemplary” is not necessarily to he construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, “include(s)”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and an application server for determining a plurality of project factors to achieve a quality associated with the project. The application server may be configured to receive input data from one or more external sources such as, but not limited to, test management system, a skill management system, project complexity analysis module and market research system. The application server computes the cost of quality (COQ), associated with the project based on the input data received from the one or more external sources. Also, the application server computes an expected value of COQ based on an ontology based process using the computed COQ and input data received from the market research system. Thereafter, the application server identifies plurality of projects factors using the computed COQ and the expected COQ. The identified plurality of project factors may be varied to achieve the predefined quality associated with the project.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may he made without departing from the scope of the present disclosure. The following description is, therefore, not to he taken in a limiting sense.

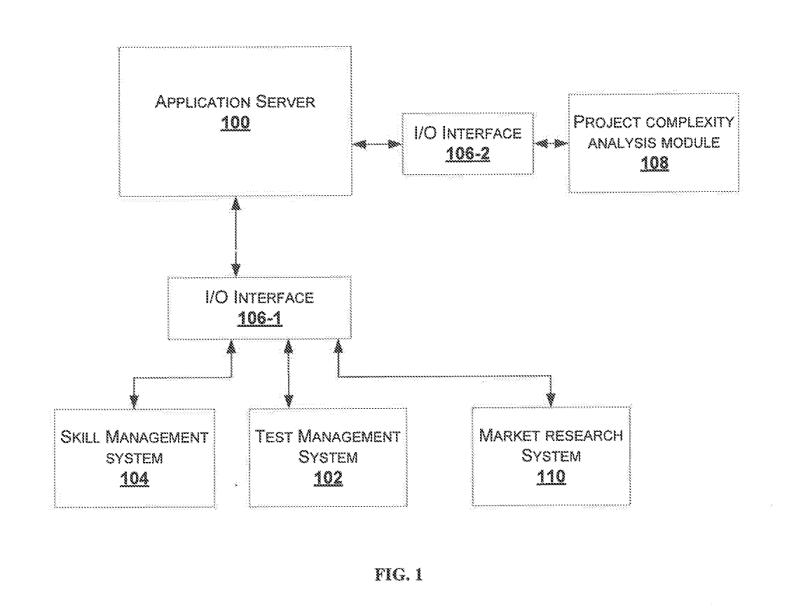

FIG. 1 shows an exemplary environment for determining a plurality of project factors to achieve a quality associated with the project, in accordance with an embodiment of the present disclosure.

As shown in the FIG. 1, the exemplary environment includes an application server 100 to determine a plurality of project factors to achieve a quality associated with the project. The application server 100 is connected to one or more external sources, such as, but not limited to, test management system 102, skill management system 104, project complexity module 108, and market research system 110, through one or more I/O interfaces 106-1, 106-2. The one or more I/O interfaces 106-1, 106-2 together is referred as an I/O interface 106.

In one embodiment, the application server 100 is an automated computing system which determines a plurality of project factors to achieve a quality associated with the project, by computing cost of quality corresponding to the project. The application server 100 receives input data from the test management system 102 and skill management system 104. The I/O interface 106-1, used by the application server 100, may be at least one of remote procedure call (RPC), application programming interface (API), hypertext transfer protocol (HTTP), open database connectivity (ODBC) and the like. The application server 100 is connected to a project complexity analysis module 108 through an I/O interface 106-2 which may be at least one of remote procedure call (RPC), application programming interface (API), socket and any other access mechanism.

The application server 100 determines a value corresponding to each of the plurality of project factors associated with the project using the input data. The one or more project factors associated with a project may be project complexity, skill deficit, total effort spent, and the like. Also, the application server 100 determines a cost of quality (COQ) of the project using the value corresponding to each of the plurality of project factors. Further, the application server 100 determines expected COQ of the project based on an ontology based process or any other similar process, using the computed COQ and data associated with a plurality of projects retrieved from a market research database, configured in a market research system 110. Thereafter, the application server 100 compares the computed COQ and the expected COQ, to determine the plurality of project factors to achieve a quality.

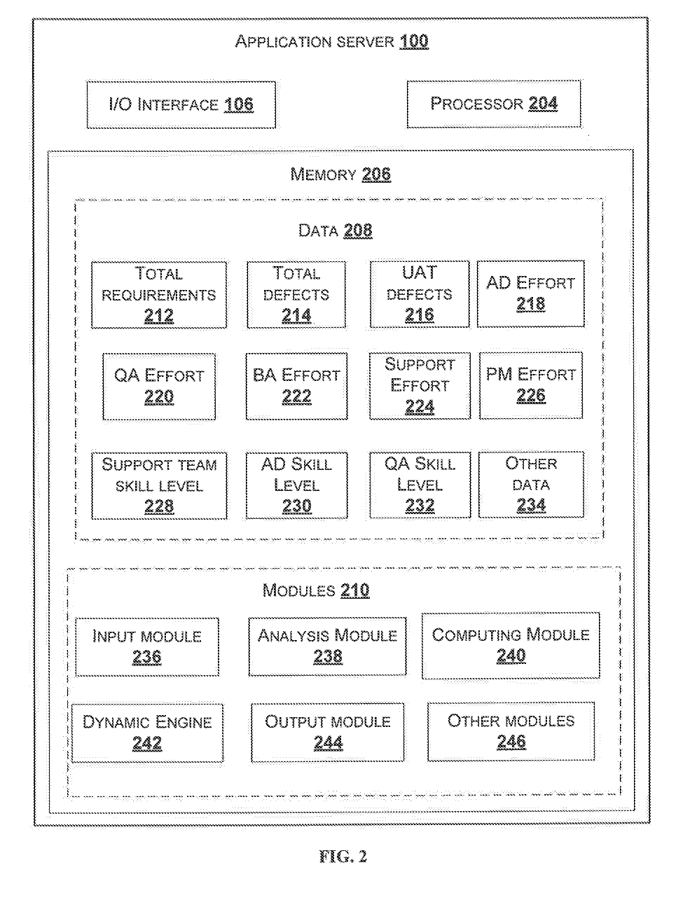

FIG. 2 shows a detailed block diagram illustrating an application server 100 for determining a plurality of project factors to achieve a quality associated with the project, in accordance with an embodiment of the present disclosure.

The application server 100 includes an I/O interface 106, a processor 204 and a memory 206. The I/O interface 106 may be configured to read and retrieve data from the test management system 102 The memory 206 may he communicatively coupled to the processor 204. The processor 204 may be configured to perform one or more functions of the application server 100 for determining the plurality of project factors to achieve a quality associated with the project. In one implementation, the application server 100 may comprise data 208 and modules 210 for performing various operations in accordance with the embodiments of the present disclosure. In an embodiment, the data 208 may be stored within the memory 206 and may include, without limiting to, total requirements 212, total defects 214, user acceptance testing (UAT) defects 216, application development (AD) effort 218, quality assurance (QA) effort 220, business analysis (BA) effort 222, support effort 224, project management (PM) effort 226, support team skill level 228, AD skill level 230, QA skill level 232, and other data 234.

In some embodiments, the data 208 may be stored within the memory 206 in the form of various data structures. Additionally, the data 208 may be organized using data models, such as relational or hierarchical data models. The other data 234 may store data, including, temporary data and temporary files, generated by modules 210 for performing the various functions of the application server 100.

In an embodiment, the total requirements 212, is a value associated with number of requirements of the project. The total requirements 212 is obtained from the test management system 102. The total defects 214 is the number of defects in requirement of the project, may be identified by a quality assurance (QA) team during requirement analysis of the project. The total defects 214 includes total defects in requirement and total defects during testing. The total defects in requirement are the defects that the QA team may identify during requirement analysis or defects that have root cause as requirements. The total defects during testing may be number of defects in testing, which corresponds to total defects the QA team had identified during testing process.

The UAT defects 216 may be identified by a user acceptance team, during the testing process. The UAT defects 216 may found after the testing team has completed the testing process. The AD effort 218 may be a total effort spent by the AD team on analysis of defects and fixing the analyzed defects. The QA effort 220 is the total effort spent by the QA team on the project. All the activities by QA team i.e. from requirement analysis, testing test case writing, defect retesting, support of UAT and production may be included in the UAT defects 216.

The BA effort 222 is the total effort spent by the BA team for fixing defects identified by the QA team. The support effort 224 may be the support team effort, that includes effort they spend in re rollout. All efforts related to unsuccessful production roll out may be captured in the BA effort 222. The PM effort 226 is total effort of the project team supporting the QA activities and effort due to roll out failure or re rollout.

In some embodiment, the data 208 may be processed by one or more modules 210 of the application server 100, In some implementation, the one or more modules 210 may be stored with the memory 206. In another implementation, the one or more modules 210 may be communicatively coupled to the processor 204 for performing one or more functions of the application server 100. The modules 210 may include, without limiting to, an input module 236, an analysis module 238, a computing module 240 a dynamic engine 242, output module 244 and other modules 246.

As used herein, the term module refers to an application specific integrated circuit (ASIC), au electronic circuit, a processor (shared, dedicated, or group) and memory that execute one or more software or firmware programs, a combinational logic circuit, and/or other suitable components that provide the described functionality. In an embodiment, the other modules 246 may be used to perform various miscellaneous functionalities of the application server 100. In one embodiment, a battery backup unit (BBU) (not shown) is configured in the application server 100 to provide backup power to the application server 100. It will be appreciated that such modules 246 may be represented as a single module or a combination of different modules.

In an embodiment, the input module 236 may be responsible for receiving input data from the test management system 102 and the skill management system 104. The input module 236 interacts with the test management system 102 through the I/O interface 106-1 and receives the input data.

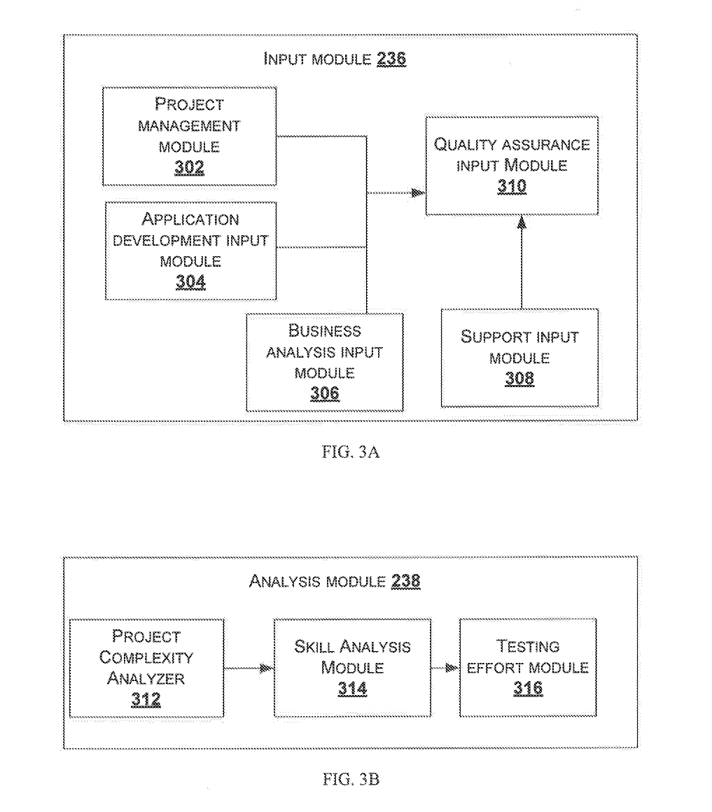

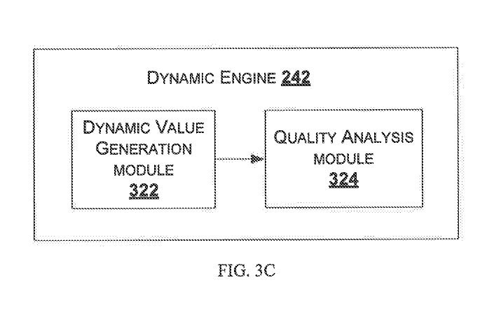

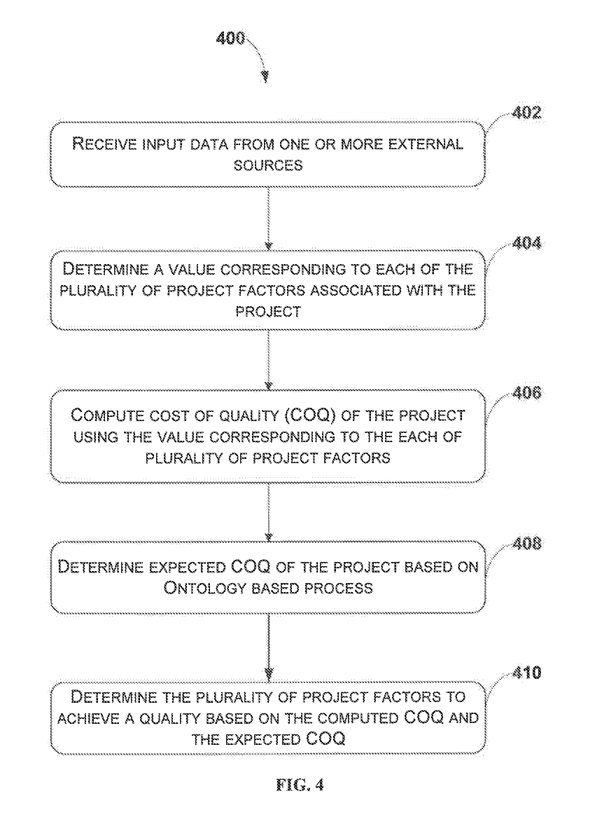

The sub modules of the input module 236 are illustrated in FIG. 3A. The sub modules of the input module 236 includes a project management (PM) module 302, an application development (AD) input module 304, a business analysis (BA) input module 306, support input module 308 and quality assurance (QA) input module 310.

The PM module 302, receives input data, which includes time spent by the PM team in defect triaging. PM team relevant experience to handle a project and overhead task handling and maintenance of other teams in the project, from the test management system 102.

The AD input module 304, receives input data, which includes unit testing data i.e. effort corresponding to testing effort, defect fixing data i.e. effort spent on fixing defects in testing, user acceptance testing (UAT) and production; production support data i.e, time spend on production roll outs, UAT support 216, and AD team skill level 230, from the test management system 102 and the skill level management system 104.

The BA input module 306, receives input data, which includes defect fixing data he, time spend by BA team in fixing QA defects; clarification data the time spent by BA team in clarifying the defects and queries raised by AD team; and BA skill to handle the project, from the test management system 102 and the skill level management system 104.

The support input module 308, receives input data, which includes rollout and rollback activities data., production support data and support team skill level 228, from the test management system 102 and the skill level management system 104.

The QA input module 310, receives input data received by the PM module 302, the AD input module 304, the BA input module 306, and the support input module 308. Also, QA input module 310 receives input data, which includes total requirements 212 i.e. time spend by QA team to understand and correct testing requirements; time spend by QA team to understand the coding and capture defects; time spent by QA team to create and execute test cases, the UAT support 216 i.e. time spent by the QA team to support UAT; production support i.e. time spend by the QA team to support production team, the QA team skill level 232, from the test management system 102 and the skill level management system 104.

Referring to FIG. 2, the analysis module 238 may be responsible for determining a value corresponding to each of the plurality of project factors associated with the project using the input data, in an embodiment of the present disclosure. The sub modules of the analysis module 238 are illustrated in FIG. 3A. The sub modules of the analysis module 238 includes project complexity analyzer 31.2, skill analysis module 314 and a testing effort module 316.

The project complexity analyzer 312 determines a value corresponding to the project complexity using the input data received from project complexity analysis module 108. The input data includes complexity data associated with the project requirements of the BA team, the QA team and the AD team; risk data and impact data associated with each module of the project, and number of test cases associated with the QA team;

In an embodiment, the project complexity analyzer 312 determines the requirement complexity value based on an average derivative of the obtained complexity data, provided by the BA team, the QA team and the AD team. For example, the determined overall complexity based on the BA team, the QA team and the AD team is illustrated in the below Tables 1 and 2. The ratio of the total requirements to assessment may be the requirement complexity.

TABLE 1

| Requirement | | Descrip- | BA | QA | AD | |
|---|---|---|---|---|---|---|
| ID | Name | tion | team | Team | Team | Average |
| 1 | Sample-1 | Sample-1 | 3 | 1 | 2 | 2 |
| 2 | Sample-2 | Sample-2 | 3 | 1 | 1 | 1.666667 |
| 3 | Sample-3 | Sample-3 | 2 | 3 | 3 | 1.666667 |

TABLE 2
Overall Risk Assessment

| | |
|---|---|
| Total Requirements | 20 |
| Assessment | 3.018518519 |
| Requirement Complexity | Complex |

The project complexity analyzer 312 uses the input received from the project complexity analysis module 108, which includes input data from the AD team on the modules 210 and risk and impact of each module. The module complexity is determined based on the data from the AD team. Also, the QA team provides the inputs of the total test cases that are available in the module to give the determination of the complexity from QA. The Table 3 below shows an illustration of the data.

TABLE 3

| Functional | Total Test | | | Total Areas |
|---|---|---|---|---|
| Area | Cases | Complexity | Risk | impacted |
| FA1 | 13 | 1 | 3 | Overall |
| FA2 | 4 | 1 | 3 | 2 |
| FA3 | 22 | 3 | 2 | 2 |
| FA4 | 9 | 1 | 3 | Overall |

Following Table 4 provides an illustration of determining test complexity value using the number of test cases:

TABLE 4

| Test Coverage | Weightage |
|---|---|
| Full testing done | Simple |
| Partial testing done | Medium |
| No testing done | Complex |

The project complexity analyzer 312 determines the project complexity using the requirement complexity value, the module complexity value and testing complexity value,

Project complexity=Requirement complexity+Testing complexity+Module complexity

An illustration of the values of project complexity is illustrated in Table 5.

TABLE 5

| | Requirement | Testing | Module | Project |
|---|---|---|---|---|
| Project | Complexity | Complexity | Complexity | complexity |
| RPJ1 | 2 | 1 | 2 | 5 |
| PRJ2 | 1 | 2 | 2 | 5 |

If the value of the project complexity is in the range of 0 and 4 then the project complexity is Simple. If the value of the project complexity is in the range of 4 and 9 then the project complexity is Medium. If the value of the project complexity is greater than 9 then the project complexity is Complex.

The skill analysis module 314 computes a value corresponding to the skill deficit, for the project. The skill analysis module 314 determines a planned skill value using the project complexity value and determines an actual skill value using the support team skill level, the application development skill level, and the quality assurance skill level data retrieved from the input data. The skill analysis module 314 computes the skill deficit from the actual skill value and the planned skill value.

Table 6 shows an illustration of obtaining the skill deficit from the actual skill value and the planned skill value.

TABLE 6

| | Planned | Project | Planned | Actual skill | Skill |
|---|---|---|---|---|---|
| Project | Skill | Complexity | skill value | available | Deficit |
| Project1 | 2 | 1.5 | 3 | 1.8 | −1.2 |
| Project2 | 3 | 1 | 3 | 1.6 | −1.4 |
| Project3 | 2 | 1 | 2 | 1.8 | −0.2 |
| Project4 | 1 | 2 | 2 | 2.2 | 0.2 |
| Project5 | 2 | 1 | 2 | 1.8 | −0.2 |
| Project6 | 3 | 1 | 3 | 2 | −1 |
| Project7 | 2 | 1.5 | 3 | 1.8 | −1.2 |
| Project8 | 2 | 1 | 2 | 1.8 | −0.2 |
| Project9 | 1 | 1 | 1 | 1.6 | 0.6 |
| Project10 | 2 | 1 | 2 | 2.8 | 0.8 |

The testing effort module 316 determines the total effort spent, by obtaining data associated with AD effort 21, QA effort 220, BA effort 222, support effort 224 and PM effort 226 from the input data. Thereafter, the testing effort module 316 determines the total effort spent by combining the data associated with the AD effort 218, the QA effort 220, the BA effort 222, the support effort 224 and the PM effort 226.

The testing effort is determined as (AD effort+QA effort+BA effort+support effort+PM effort).

Table 6 shows an illustration of obtaining the total effort spent:

TABLE 6

| AD | QA | BA | Support | PM | Total |
|---|---|---|---|---|---|
| effort | effort | effort | Effort | effort | effort |
| 100 | 456 | 235 | 456 | 775 | 2022 |
| 200 | 100 | 300 | 100 | 123 | 823 |
| 300 | 300 | 456 | 775 | 100 | 1931 |
| 100 | 775 | 100 | 300 | 456 | 1731 |
| 400 | 2345 | 775 | 333 | 100 | 3953 |
| 500 | 775 | 300 | 775 | 300 | 2650 |
| 775 | 300 | 100 | 100 | 567 | 1842 |
| 678 | 456 | 13 | 456 | 775 | 2378 |
| 456 | 435 | 300 | 100 | 234 | 1525 |
| 2334 | 345 | 453 | 111 | 300 | 3543 |
| 110 | 300 | 775 | 300 | 456 | 1941 |

Referring back to FIG. 2, the computing module 240 computes the cost of quality (COQ) of the project based on the total effort spent, the project complexity and the skill deficit.

COQ is determined as (Total Effort Spend−Project Complexity*Total effort Spend)/2*(Skill Deficit).

Table 7 shows an illustration of computing COQ:

TABLE 7

| Project | Skill Deficit | Project Complexity | Total effort | COQ |
|---|---|---|---|---|
| Project1 | −1.2 | 1.5 | 2022 | −1.2 |
| Project2 | −1.4 | 1 | 823 | −1.4 |
| Project3 | −0.2 | 1 | 1931 | −0.2 |
| Project4 | 0.2 | 2 | 1731 | 0.2 |
| Project5 | −0.2 | 1 | 3953 | −0.2 |
| Project6 | −1 | 1 | 2650 | −1 |
| Project7 | −1.2 | 1.5 | 1842 | −1.2 |
| Project8 | −0.2 | 1 | 2378 | −0.2 |
| Project9 | 0.6 | 1 | 1525 | 0.6 |
| Project10 | 0.8 | 1 | 3543 | 0.8 |

The sub modules of the dynamic engine 242 are illustrated in FIG. 3C. The sub modules of the dynamic engine 242 includes a dynamic value generation module 322 and quality analysis module 324. The dynamic engine 242 receives input data from the skill management system 104 and market research system 110. The dynamic value generation module 322 receives data associated with each of the plurality of projects from the market research database, configured in the market research system 110. The data associated may he project effort value, skill deficit value and project complexity value. The dynamic value generation module 322 compares the plurality of project factors of the project with the obtained data from the market research database, to generate a plurality of comparison values.

For example, let the quality analysis module 324 receives Project1 data. Based on the comparison of Project1 data with plurality of projects received from the market research database. Project25 data may be the closest to the Project1 data. Table 7 shows an illustration of the Project1 and Project25 data:

TABLE 7

| Project | Skill Deficit | Project Complexity | Total effort |
|---|---|---|---|
| Project1 | −1.2 | 1.5 | 2022 |
| Project25 | −0.9 | 1.485 | 2022 |

As shown in the Table 7, the accuracy of the data is about 99% as the complexity match is about 99%. Also, as the skill deficit is about 75%, so the application server 100 provides a confidence value of about 75% on Project25. The data as shown in Table 8 is dynamically generated, whenever an input data is received by the application server 100.

TABLE 8

| | Project | Confidence | Accuracy |
|---|---|---|---|
| Project1 | Project25 | 75% | 99% |
| Project2 | Project10 | 90% | 24% |
| Project3 | Project10 | 100% | 34% |
| Project4 | Project5 | 50% | 45% |
| Project5 | Project7 | 25% | 67% |
| Project6 | Project25 | 35% | 89% |
| Project7 | Project10 | 45% | 90% |
| Project8 | Project25 | 65% | 23% |
| Project9 | Project6 | 76% | 100% |
| Project10 | Project1 | 89% | 25% |

In an embodiment, after generating the data as shown in Table 7, the quality analysis module 324 initiates an ontology based process, which uses an artificial intelligence (AI), to determine an expected value of the COQ of the project. The ontology based process obtains data associated with each of the plurality of projects from the market research database. The data includes project effort value, skill deficit value and project complexity value. Next, ontology based process compares the plurality of project factors of the project with the obtained data from the market research database, to generate a plurality of comparison values. Thereafter, the ontology based process identifies a market research project from the plurality of projects, based on a lowest comparison value from the generated plurality of comparison values and obtains a COQ value of the market research project to determine the expected COQ value of the project.

In an embodiment, the ontology based process includes an accuracy value may he generated by comparing the project complexity associated with the project and the project complexity associated with the identified market research project. Next, a confidence value may he generated by comparing the skill deficit associated with the project and a skill deficit associated the identified market research project. Thereafter, an actual effort of the project may be computed using the accuracy value and the confidence value, thereby generating actual COQ of the project.

In an embodiment, the ontology based process, configured in the dynamic engine 242, stores the data, associated with the plurality of parameters of the project, in the memory 206 based on a learning application. The learning application initiates the storing of the data based on the accuracy value and the project complexity.

Table 9 shows an illustration of the confidence, accuracy and AI result values:

TABLE 9

| | Project | Confidence | Accuracy | AI Result |
|---|---|---|---|---|
| Project1 | Project25 | 75% | 99% | 74% |
| Project2 | Project10 | 90% | 24% | 22% |
| Project3 | Project10 | 100% | 34% | 34% |
| Project4 | Project5 | 50% | 45% | 23% |
| Project5 | Project7 | 25% | 67% | 17% |
| Project6 | Project25 | 35% | 89% | 31% |
| Project7 | Project10 | 45% | 90% | 41% |
| Project8 | Project25 | 65% | 23% | 15% |
| Project9 | Project6 | 76% | 100% | 76% |
| Project10 | Project1 | 89% | 25% | 22% |

In an embodiment, the ontology based process uses the total effort to obtain the COQ. Thereafter, an average cost of each hour is estimated. A positive result determines the accuracy is good. A negative value estimates that the AI could not determine and is learning based on the inputs. The obtained data is stored in a learning database.

In an embodiment, the application server 100 transmits the obtained COQ value to at least one of Share point and an email system,

Table 10 shows an illustration of computed cost of quality.

TABLE 10

| | COQ | AI result | Computed Cost of Quality |
|---|---|---|---|
| Project1 | 3285.75 | 74% | $287,641.41 |
| Project2 | 1116.929 | 22% | $336,112.76 |
| Project3 | 6758.5 | 34% | $1,292,066.18 |
| Project4 | −6924 | 23% | ($2,000,266.67) |
| Project5 | 13835.5 | 17% | $5,369,000.00 |
| Project6 | 3975 | 31% | $829,454.25 |
| Project7 | 2993.25 | 41% | $480,398.15 |
| Project8 | 8323 | 15% | $3,618,695.65 |
| Project9 | 254.1667 | 76% | $21,737.94 |
| Project10 | 1328.625 | 22% | $388,137.64 |

Referring back to FIG. 2, the output module 244 determines the plurality of project factors to achieve a quality based on the computed COQ and the expected COQ. The COQ facilitates a project management team to determine an amount being spent. Based on the computed COQ and expected COQ, the application server 100 provides a positive signal for the execution of the project.

In an embodiment, a user inputs a quality range for the project, that needs to be achieved. For example, considering Project1 is spending about $287,641.41 for a quality. The user may provide a range of quality, such as, but not limited to

Quality value is in a range of 80% and 100%, then cost may be $287,641.41.

If Quality value is in a range of 50% and 80% then the total cost may be 50% of the overall cost, i.e. half of the cost $287,641.41.

In an embodiment, the output module 244 provides an overall cost spend on the project based on the quality being inputted by the user i.e. actual cost of quality. Also, the output module 244, provides the change in values of the plurality of project factors to achieve a quality associated with the project.

The application server 100 computes the COQ based on the input data, and expected COQ using the computed cost and data associated with market research database. Thereafter, the application server 100 using the estimated quality range inputted by the user computes the actual COQ. Table 11 shows an illustration of COQ, estimated quality, expected quality and actual quality.

TABLE 11

| | Cost of Quality | Estimated | Expected | Actual |
|---|---|---|---|---|
| | Computed | Quality | quality | quality |
| PRJ1 | $287,641.41 | 100% | 95% | 95% |
| PRJ2 | $336,112.76 | 100% | 97% | 97% |
| PRJ3 | $1,292,066.18 | 100% | 70% | 70% |
| PRJ4 | ($2,000,266.67) | 100% | 50% | 50% |
| PRJ5 | $5,369,000.00 | 100% | 100% | 100% |
| PRJ6 | $829,454.25 | 100% | 65% | 65% |

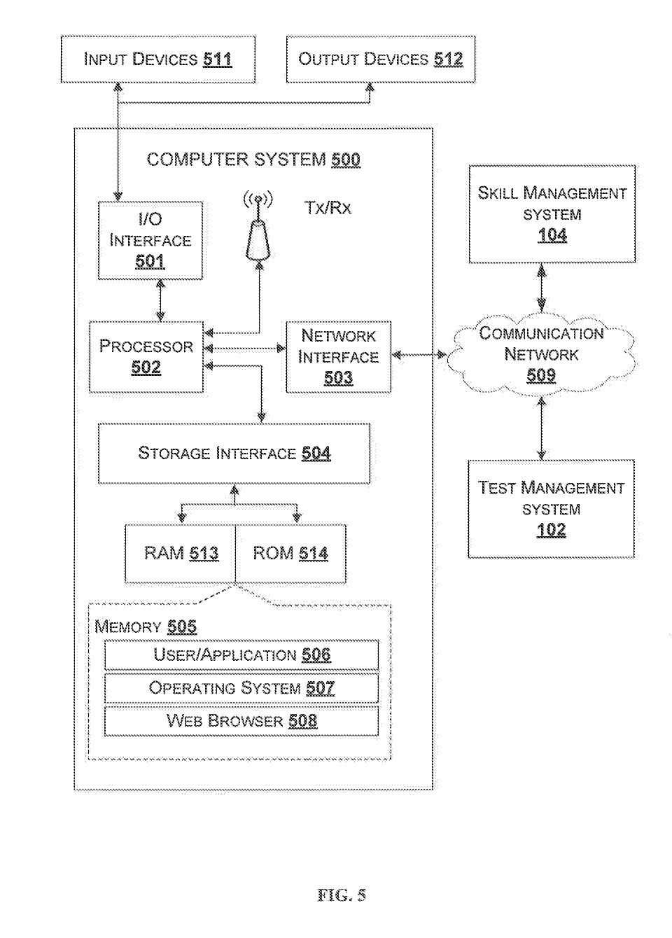

FIG. 4 shows a flowchart illustrating a for determining a plurality of project factors to achieve a quality associated with the project, in accordance with some embodiments of the present disclosure.

As illustrated in FIG. 4, the method 400 comprises one or more blocks for depicting an application server 100 for determining a plurality of project factors to achieve a quality associated with the project. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 402, an input module 236, configured in the application server 100 receives input data from one or more external sources. The input module 236 receives the input data, associated with the project from the test management system 102, skill management system 104 and a market research system 110, through the I/O interface 106. The input data includes data corresponding to total requirements of the project, total defects in requirements, total defects during testing, user acceptance test defects, production defects, production support, user acceptance testing (UAT) support, application development (AD) effort, quality assurance (QA) effort, business analysis (BA) effort, support effort, project management (PM) effort, support team skill level, AD skill level, and QA skill level.

At block 404, an analysis module 238, configured in the application server 100 receives input data to determine a value corresponding to one or more project factors, associated with the project. The one or more project factors associated with a project is project complexity, skill deficit and total effort spent.

The method of determining project complexity includes obtaining a complexity data, associated with business analysis team, application development team, and quality assurance team from the input data. Also, obtaining risk data and impact data associated with each module of the project, and number of test cases associated with the QA team. Further, determining a requirement complexity value based on an average derivative of the obtained complexity data. Furthermore, determining a module complexity value using the risk data and impact data associated with each module of the project. Thereafter, determining a testing complexity value using the number of test cases and computing the project complexity using the requirement complexity value, the module complexity value and testing complexity value.

The method of determining a value corresponding to the skill deficit includes determining a planned skill value using the project complexity value and determining an actual skill value using the support team skill level, the application development skill level, and the quality assurance skill level data retrieved from the input data. Thereafter, computing the skill deficit from the actual skill value and the planned skill value.

The method of determining a value corresponding to the total effort spent includes obtaining data associated with AD effort, QA effort, BA effort, PM effort from the input data. Thereafter, determining the total effort spent by combining the data associated with the AD effort, the QA effort, the BA effort and the PM effort.

At block 406, a computing module 240, configured in the application server 100, computes the cost of quality (COQ) of the project using the determined total effort spent, the project complexity and the skill deficit values, based on a below equation:

Total Effort Spend−Project Complexity*Total effort Spend)/2*(Skill Deficit)

At block 408, a dynamic engine 242, configured in the application server 100, determines expected COQ of the project based on an ontology based process. The ontology based process uses the computed COQ and data associated with a plurality of projects retrieved from a market research database for determining expected COQ.

At block 410 an output module 244, configured in the application server 100, determines the plurality of project factors to achieve a quality based on the computed COQ and the expected COQ.

### Computer System

FIG. 5 illustrates a block diagram of an exemplary computer system 500 for implementing embodiments consistent with the present invention. In an embodiment, the computer system 500 may be an application server 100 which is used for determining a plurality of project factors to achieve a quality associated with the project. The computer system 500 may comprise a central processing unit (“CPU” or “processor”) 502. The processor 502 may comprise at least one data processor for executing program components for executing user- or system-generated business processes. A user may include a person, a person using a device such as such as those included in this invention, or such a device itself. The processor 502 may include specialized processing units such as integrated system (bus) controllers, memory management control units, floating point units, graphics processing units, digital signal processing units, etc.

The processor 502 may he disposed in communication with one or more input/output (I/O) devices ( 511 and 512 ) via I/O interface 501. The I/O interface 501 may employ communication protocols/methods such as, without limitation, audio, analog, digital, stereo, IEEE-1394, serial bus, Universal Serial Bus (USE), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 501, the computer system 500 may communicate with one or more I/O devices ( 511 and 512).

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may communicate with one or more external sources, such as, but not limited to test management system 102 and skill management system 104, for receiving input data and determining a plurality of project factors to achieve a quality associated with the project. The communication network 509 can be implemented as one of the different types of networks, such as intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission. Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application data 506, an operating system 507, web server 508 etc. In some embodiments, computer system 500 may store user/application data 506, such as the data, variables, records, etc. as described in this invention. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc,). Linux distributions (e.g., Red Hat, Ubuntu, K-Ubuntu, etc.), International Business Machines (IBM) OS/2, Microsoft Windows (XP, Vista/7/8, etc,), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User interfaces (GUIs) may he employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc, Web browsers may utilize facilities such as AJAX, DHTML, Adobe Flash, JavaScript, Java, Application Programming interfaces (APIs), etc. In some embodiments, the computer system 500 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Present Disclosure are Illustrated herein.

In an embodiment, the present disclosure discloses a method for determining a plurality of project factors to achieve a quality associated with the project.

In an embodiment, the method of present disclosure is easy to implement

In an embodiment, the method of present disclosure helps the organizations in understanding the amount of quality assurance spent, with better visibility.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate or not) may be used in place of a single device/article. Similarly, where more than one device or article is described herein (whether they cooperate or not), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Application Server |
| 102 | Test management system |
| 104 | Skill management system |
| 106-1, 106-2 | I/O Interface |
| 108 | Project complexity analysis module |
| 110 | Market research system |
| 204 | Processor |
| 206 | Memory |
| 208 | Data |
| 210 | Modules |
| 212 | Total requirements |
| 214 | Total defects |
| 216 | UAT defects |
| 218 | AD effort |
| 220 | QA effort |
| 222 | BA effort |
| 224 | Support effort |
| 226 | PM effort |
| 228 | Support team skill level |
| 230 | AD skill level |
| 232 | QA skill level |
| 234 | Other data |
| 236 | Input module |
| 238 | Analysis module |
| 240 | Computing module |
| 242 | Dynamic engine |
| 244 | Output module |
| 246 | Other modules |
| 302 | Project management (PM) module |
| 304 | Application development (AD) input module |
| 306 | Business analysis (BA) input module |
| 308 | Support input module |
| 310 | Quality assurance (QA) input module |
| 312 | Project complexity analyzer |
| 314 | Skill analysis module |
| 316 | Testing effort module |
| 322 | Dynamic value generation module |
| 324 | Quality analysis module |

What is claimed is:

1. A method for determining a plurality of project factors to achieve a quality associated with the project, the method comprising:
receiving, by an application server 100, input data from one or more external sources;
determining, by the application server 100, a value corresponding to each of the plurality of project factors associated with the project using the input data;
computing, by the application server 100, cost of quality (COQ) of the project using the value corresponding to the each of the plurality of project factors;
determining, by the application server 100, expected COQ of the project based on an ontology based process, using the computed COQ and data associated with a plurality of projects retrieved from a market research database; and
determining, by the application server 100, the plurality of project factors to achieve a quality based on the computed COQ and the expected COQ.

2. The method as claimed in claim 1, wherein the input data includes data corresponding to total requirements of the project, total defects in requirements, total defects during testing, user acceptance test defects, production defects, production support, user acceptance testing (UAT) support, application development (AD) effort, quality assurance (QA) effort, business analysis (BA) effort, support effort, project management (PM) effort, support team skill level, AD skill level, and QA skill level.

3. The method as claimed in claim 1, wherein the one or more external sources is a test management system 102 and a skill management system 104.

4. The method as claimed in claim 1, wherein the one or more project factors associated with a project is project complexity, skill deficit and total effort spent.

5. The method as claimed in claim 4, wherein determining a value corresponding to the project complexity comprises:
obtaining complexity data, associated with business analysis team, application development team, and quality assurance team from the input data; risk data and impact data associated with each module of the project, and number of test cases associated with the QA team;
determining a requirement complexity value based on an average derivative of the obtained complexity data;
determining a module complexity value using the risk data and impact data associated with each module of the project;
determining a testing complexity value using the number of test cases; and
computing the project complexity using the requirement complexity value, the module complexity value and testing complexity value.

6. The method as claimed in claim 4, wherein determining a value corresponding to the skill deficit comprises:
determining a planned skill value using the project complexity value;
determining an actual skill value using the support team skill level, the application development skill level, and the quality assurance skill level data retrieved from the input data; and
computing the skill deficit from the actual skill value and the planned skill value.

7. The method as claimed in claim 4, wherein determining a value corresponding to the total effort spent comprises:
obtaining data associated with AD effort, QA effort, BA effort, PM effort from the input data; and
determining the total effort spent by combining the data associated with the AD effort, the QA effort, the BA effort and the PM effort.

8. The method as claimed in claim 1, wherein the cost of quality (COQ) of the project is computed based on the total effort spent, the project complexity and the skill deficit.

9. The method as claimed in claim 1, wherein determining the expected value of the COQ of the project based on the ontology based process comprises:
obtaining data associated with each of the plurality of projects from the market research database comprising project effort value, skill deficit value and project complexity value;
comparing the plurality of project factors of the project with the obtained data from the market research database, to generate a plurality of comparison values;
identifying a market research project from the plurality of projects, based on a lowest comparison value from the generated plurality of comparison values; and
obtaining a COQ value of the market research project, thereby determining the expected COQ value of the project.

10. The method as claimed in claim 9, wherein determining the expected value of the COQ by the ontology based process further comprises;
generating an accuracy value, associated with the project, by comparing the project complexity of the project with a corresponding project complexity associated with the identified market research project;
generating a confidence value, associated with the project, by comparing the skill deficit of the project with a corresponding skill deficit value associated the identified market research project; and
computing an actual effort of the project using the accuracy value and the confidence value, thereby generating actual COQ of the project.

11. The method as claimed in claim 10, wherein the ontology based process comprises storing the data, associated with the plurality of parameters of the project, by a learning application based on the accuracy value and the project complexity.

12. The method as claimed in claim 9, wherein analyzing the computed COQ with the expected COQ comprises:
receiving a quality range of the project, inputted by a user;
generating COQ based on the quality range and the actual COQ; and
identifying values of the plurality of project factors associated with the project, to achieve the predefined COQ.

13. An application server 100 for determining a plurality of project factors to achieve a quality associated with the project, the application server 100 comprising:
a processor 204; and
a memory 206, communicatively coupled to the processor 204, wherein the memory 206 stores processor-executable instructions, which, on execution, causes the processor 204 to:
receive input data from one or more external sources;
determine a value corresponding to each of the plurality of project factors associated with the project using the input data;
compute cost of quality (COQ) of the project using the value corresponding to the each of the plurality of project factors;
determine expected COQ of the project based on an ontology based process, using the computed. COQ and data associated with a plurality of projects retrieved from a market research database; and
determine the plurality of project factors to achieve a quality based on the computed COQ and the expected COQ.

14. The server as claimed in claim 13, wherein the input data includes data corresponding to total requirements of the project, total defects in requirements, total defects during testing, user acceptance test defects, production defects, production support, user acceptance testing (UAT) support, application development (AD) effort, quality assurance (QA) effort, business analysis (BA) effort, support effort, project management (PM) effort, support team skill level, AD skill level, and QA skill level.

15. The server as claimed in claim 13, wherein the one or more external sources is a test management system 102 and a skill management system 104.

16. The system as claimed in claim 13, wherein the one or more project factors associated with a project is project complexity, skill deficit and total testing effort spent.

17. The system as claimed in claim 16, wherein to determine a value corresponding to the project complexity, the instructions causes the processor 204 to:
obtain complexity data, associated with business analysis team, application development team, and quality assurance team from the input data; risk data and impact data associated with each module of the project, and number of test cases associated with the QA team;
determine a requirement complexity value based on an average derivative of the obtained complexity data;
determine a module complexity value using the risk data and impact data associated with each module of the project;
determine a testing complexity value using the number of test cases; and
compute the project complexity using the requirement complexity value, the module complexity value and testing complexity value.

18. The system as claimed in claim 16, wherein to determine a value corresponding to the skill deficit, the instructions causes the processor 204 to:
determine a planned skill value using the project complexity value;
determine an actual skill value using the support team skill level, the application development skill level, and the quality assurance skill level data retrieved from the input data; and
compute the skill deficit from the actual skill value and the planned skill value.

19. The system as claimed in claim 16, wherein to determine a value corresponding to the total effort spent, the instructions causes the processor 204 to:
obtain data associated with AD effort, QA effort, BA effort, PM effort from the input data; and
determine the total effort spent by combining the data associated with the AD effort, the QA effort, the BA effort and the PM effort.

20. The system as claimed in claim 13, wherein the cost of quality (COQ) of the project is computed based on the total effort spent, the project complexity and the skill deficit.

21. The system as claimed in claim 13, wherein to determine the expected value of the COQ of the project based on the ontology based process, the instructions causes the processor 204 to:
obtain data associated with each of the plurality of projects from the market research database comprising project effort value, skill deficit value and project complexity value;
compare the plurality of project factors of the project with the obtained data from the market research database, to generate a plurality of comparison values;
identify a market research project from the plurality of projects, based on a lowest comparison value from the generated plurality of comparison values; and
obtain a COQ value of the market research project, thereby determining the expected COQ value of the project.

22. The system as claimed in claim 21, wherein to determine the expected value of the COQ by the ontology based process, the instructions further causes the processor 204 to:
generate an accuracy value, associated with the project, by comparing the project complexity of the project with a corresponding project complexity associated with the identified market research project;
generate a confidence value, associated with the project, by comparing the skill deficit of the project with a corresponding skill deficit value associated the identified market research project; and
compute an actual effort of the project using the accuracy value and the confidence value, thereby generating actual COQ of the project.

23. The system as claimed in claim 22, wherein the ontology based process causes the processor 204 to store the data, associated with the plurality of parameters of the project, by a learning application based on the accuracy value and the project complexity.

24. The system as claimed in claim 21, wherein to analyze the computed COQ with the expected COQ, the instructions causes the processor 204 to:
receive a quality range of the project, inputted by a user;
generate COQ based on the quality range and the actual COQ; and
identify values of the plurality of project factors associated with the project, to achieve the predefined COQ.

25. A non-transitory computer readable medium including instructions stored thereon that when processed by at least one processor 204 cause an application server 100 to perform acts of:
receiving input data from one or more external sources;
determining a value corresponding to each of the plurality of project factors associated with the project using the input data;
computing cost of quality (COQ) of the project using the value corresponding to the each of the plurality of project factors;
determining expected COQ of the project based on an ontology based process, using the computed COQ and data associated with a plurality of projects retrieved from a market research database; and
determining the plurality of project factors to achieve a quality based on the computed COQ and the expected COQ.
